(19) United States
(12) Patent Application Publication
(10) Pub. No.: US 2021/0407479 A1
(43) Pub. Date: Dec. 30, 2021

(54) METHOD FOR SONG MULTIMEDIA SYNTHESIS, ELECTRONIC DEVICE AND STORAGE MEDIUM

(71) Applicant: BEIJING BAIDU NETCOM SCIENCE AND TECHNOLOGY CO., LTD., Beijing (CN)

(72) Inventors: Siyuan WU, Beijing (CN); Chao LI, Beijing (CN); Chenxi SUN, Beijing (CN)

(73) Assignee: BEIJING BAIDU NETCOM SCIENCE AND TECHNOLOGY CO., LTD., Beijing (CN)

(21) Appl. No.: 17/474,776

(22) Filed: Sep. 14, 2021

(30) Foreign Application Priority Data
Oct. 27, 2020 (CN) 202011164612.6

(51) Int. Cl. G10H 1/00; G10H 1/06; G11B 27/031

(52) U.S. Cl. CPC G10H 1/0025; G10H 1/06; G10H 2210/315; G10H 2210/056; G10H 2210/105; G11B 27/031

(57) ABSTRACT

The disclosure provides a method for synthesizing a song multimedia, an electronic device and a storage medium. Material obtaining modes are provided based on a song multimedia synthesis request. User audios provided by a user are obtained based on a selected material obtaining mode. A user timbre output by a timbre extraction model is obtained by inputting the user audios into the timbre extraction model. Lyrics to be synthesized and a tune to be synthesized provided by the user are obtained based on the selected material obtaining mode, and a synthesized song multimedia is obtained by inputting the user timbre, the lyrics to be synthesized and the tune to be synthesized into a song synthesis model.

### CROSS REFERENCE TO RELATED APPLICATIONS

This application claims priority and benefits to Chinese Application No. 202011164612.6, filed on Oct. 27, 2020, the entire content of which is incorporated herein by reference.

### TECHNICAL FIELD

The disclosure relates to the field of computer techniques, specifically relates to fields of speech technologies and deep learning technologies, more particularly to a method for synthesizing a song multimedia, an apparatus for song multimedia synthesis, an electronic device, and a storage medium.

### BACKGROUND

In the related art, music synthesizing methods mainly generate singing effect of a user by obtaining speech materials provided by the user, and editing and processing timbre of the speech materials.

### SUMMARY

In one embodiment, a method for synthesizing a song multimedia is provided. The method includes: providing material obtaining modes based on a song multimedia synthesis request; obtaining user audios provided by a user based on a selected material obtaining mode; obtaining a user timbre output by a timbre extraction model by inputting the user audios into the timbre extraction model; and obtaining lyrics to be synthesized and a tune to be synthesized provided by the user based on the selected material obtaining mode, and obtaining a synthesized song multimedia by inputting the user timbre, the lyrics to be synthesized and the tune to be synthesized into a song synthesis model.

In one embodiment, an electronic device is provided. The electronic device includes: at least one processor and a memory communicatively coupled to the at least one processor. The memory stores instructions executable by the at least one processor, and when the instructions are executed by the at least one processor, the at least one processor executes the method for song multimedia synthesis according to embodiments of the disclosure.

In one embodiment, a non-transitory computer-readable storage medium is provided, storing computer instructions, the computer instructions are configured to make a computer to execute the method for song multimedia synthesis according to embodiments of the disclosure.

It should be understood that the content described in this section is not intended to identify key or important features of the embodiments of the disclosure, nor is it intended to limit the scope of the disclosure. Additional features of the disclosure will be easily understood based on the following description.

### BRIEF DESCRIPTION OF THE DRAWINGS

The drawings are used to better understand the solution and do not constitute a limitation to the disclosure, in which:

FIG. 1 is a schematic diagram of a first embodiment of the disclosure.

FIG. 2 is a schematic diagram of a second embodiment of the disclosure.

FIG. 3 is a schematic diagram of a third embodiment of the disclosure.

FIG. 4 is a schematic diagram of a fourth embodiment of the disclosure.

FIG. 5 is a block diagram of an electronic device used to implement the method for synthesizing a song multimedia according to embodiments of the disclosure.

### DETAILED DESCRIPTION

The following describes the exemplary embodiments of the disclosure with reference to the accompanying drawings, which includes various details of the embodiments of the disclosure to facilitate understanding, which shall be considered merely exemplary. Therefore, those of ordinary skill in the art should recognize that various changes and modifications can be made to the embodiments described herein without departing from the scope and spirit of the disclosure. For clarity and conciseness, descriptions of well-known functions and structures are omitted in the following description.

In the related art, manual editing and processing of timbre require a long duration, for example, from one week to half a month, so that the editing duration is long, cost is high, and the singing effect obtained by the editing is poor.

Therefore, embodiments of the disclosure provide a method for song multimedia synthesis, an apparatus for song multimedia synthesis, an electronic device and a storage medium, which will be described with reference to the following drawings.

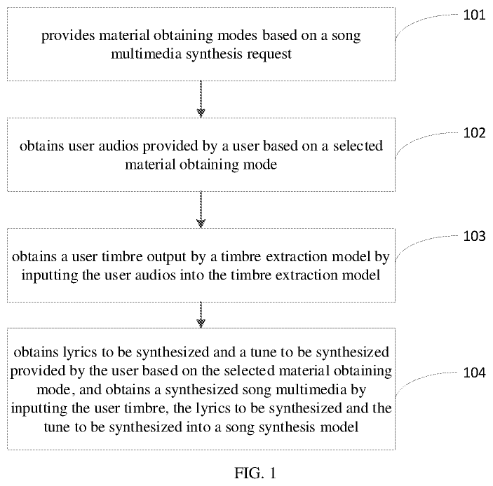

FIG. 1 is a schematic diagram of a first embodiment of the disclosure. It should be noted that an execution subject of the disclosure is an apparatus for song multimedia synthesis. In detail, the apparatus for song multimedia synthesis may be a hardware device, or software in a hardware device.

As illustrated in FIG. 1, the method for song multimedia synthesis includes the following.

At block 101, material obtaining modes are provided based on a song multimedia synthesis request.

For example, a trigger condition of the song multimedia synthesis request may be a click operation on a preset button, a present control, or a preset region in the apparatus for song multimedia synthesis, which may be set according to actual requirements.

Materials for the song multimedia synthesis may include at least one of timbre materials, lyrics materials, tune materials, music resources and video resources. The music resources include background music and/or sound effects. The video resources may be background videos. Correspondingly, the material obtaining modes may include at least one of modes for obtaining the materials.

At block 102, user audios provided by a user are obtained based on a selected material obtaining mode.

The material obtaining modes include a timbre material obtaining mode. The timbre material obtaining mode includes a user audio inputting (entering) interface and/or a user audio uploading interface. Correspondingly, the block 102 executed by the apparatus for song multimedia synthesis may include collecting the user audios by an audio inputting (collecting) device, based on an instruction of selecting the user audio inputting interface; or, obtaining the user audios uploaded by the user based on an instruction of selecting the user audio uploading interface.

By providing the user audio inputting interface and/or the user audio uploading interface, the user may upload existing user audios or the user audio can be recorded online and provided to the apparatus when there is no existing user audio. Therefore, the user can provide timbre materials according to their own conditions. In this way, the method for providing timbre materials is expanded, the number of operations required to generate the song multimedia using the user's own timbre is reduced, synthesis cost of the song multimedia is reduced, and synthesis efficiency of the song multimedia is improved.

The timbre material obtaining mode further includes one or more of following modes: a user timbre uploading interface, a designated timbre list, a historical timbre list, and a shared timbre list. The historical timbre list includes user timbres uploaded or extracted in a historical time period. The shared timbre list includes user timbres shared in a historical time period. Correspondingly, the apparatus for song material synthesis can obtain the timbre materials by obtaining an uploaded or selected user timbre based on an instruction of selecting the user timbre uploading interface, the designated timbre list, the historical timbre list, or the shared timbre list.

When the user has a stored user timbre, the user may upload the stored user timbre directly through the user timbre uploading interface. In addition, the user may select a timbre from the designated timbre list, the historical timbre list and the shared timbre list as the user timbre. The designated timbre list has timbres that can be provided by the apparatus by default. The historical timbre list may include user timbres uploaded or extracted by the user in the historical time period. The shared timbre list may include user timbres shared by other users in the historical time period. The historical time period may be, for example, one week or two weeks, which may be set according to actual requirements.

In the disclosure, the method for providing the timbre materials is expanded, that the number of operations required to generate song multimedia using the user's own timbre is reduced, synthesis cost of the song multimedia is reduced, and synthesis efficiency of the song multimedia is improved.

At block 103, a user timbre output by a timbre extraction model is obtained by inputting the user audios into the timbre extraction model.

The input of the timbre extraction model is the user audio and the output of the timbre extraction model is the user timbre in the user audio. The timbre extraction model may be a deep neural network model, which may be obtained through training based on a large number of audio samples and corresponding timbre samples, so as to extract the timbre of the user audio.

At block 104, lyrics to be synthesized and a tune to be synthesized provided by the user are obtained based on the selected material obtaining mode, and a synthesized song multimedia is obtained by inputting the user timbre, the lyrics to be synthesized and the tune to be synthesized into a song synthesis model.

The material obtaining modes further include: a lyrics material obtaining mode. The lyric material obtaining mode includes one or more of following modes: a lyric uploading interface, a designated lyric list, a historical lyric list, and a shared lyric list. The designated lyrics list may have stored lyrics that can be provided by the apparatus for song multimedia synthesis by default. The historical lyrics list may include lyrics uploaded by users in the historical time period. The shared lyrics list may include lyrics shared by other users in the historical time period. The historical time period may be, for example, one week or two weeks, which may be set according to actual needs.

The method for obtaining the lyrics to be synthesized may include: obtaining uploaded or selected lyrics based on an instruction of selecting the lyrics upload interface, the designated lyrics list, the historical lyrics list, or the shared lyrics list.

In the disclosure, based on the multiple lyrics material obtaining modes, the lyrics materials provided or selected by the user are further expanded, the number of operations required to provide the lyrics material is reduced, the number of operations required to generate the song multimedia using the user's own timbre is reduced, the synthesis cost of the song multimedia is reduced, and the synthesis efficiency of the song multimedia is improved.

The material obtaining modes further include: a tune material obtaining mode. The tune material obtaining mode includes one or more of following modes: a tune uploading interface, a designated tune list, a historical tune list and a shared tune list. The designated tune list may have stored tune that can be provided by the apparatus for song multimedia synthesis by default. The historical tune list may include tunes uploaded by users in a historical time period. The shared tune list may include tunes shared by other users in the historical time period. The historical time period may be, for example, one week or two weeks, which may be set according to actual needs.

The method for obtaining the tune to be synthesized may include: obtaining an uploaded or selected user tune based on an instruction of selecting the tune uploading interface, the designated tune list, the historical tune list, or the shared tune list.

In the disclosure, based on multiple tune material obtaining modes, the tune materials provided or selected by the user are expanded, the number of operations required to provide the tune material is reduced, the number of operations required to generate the song multimedia using the user's own timbre is reduced, the synthesis cost of the song multimedia is reduced, and synthesis efficiency of the song multimedia is improved.

In conclusion, the material obtaining modes are displayed based on a song multimedia synthesis request. The user audios provided by a user is obtained based on the selected material obtaining mode. The user timbre output by the timbre extraction model is obtained by inputting the user audios into the timbre extraction model. The lyrics to be synthesized and the tune to be synthesized provided by the user are obtained based on the selected material obtaining mode, and the synthesized song multimedia is obtained by inputting the user timbre, the lyrics to be synthesized and the tune to be synthesized into the song synthesis model. Therefore, the methods for providing the materials by the user are expanded, such that the user can provide various materials based on their own conditions, the number of operations required to generate the song multimedia with their own timbre is reduced, the synthesis cost of the song multimedia is reduced, and the synthesis efficiency of the song multimedia is improved.

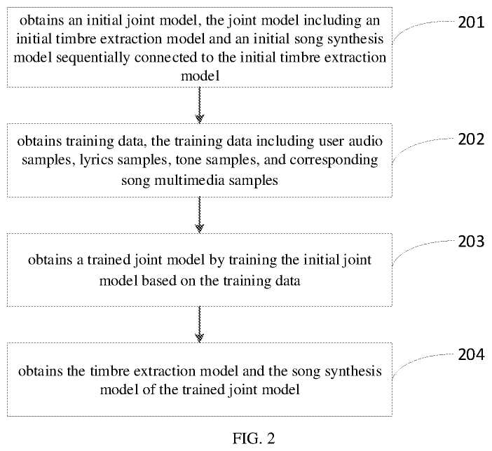

In order to improve accuracy of the timbre extraction model and the song synthesis model, the apparatus for song multimedia synthesis may perform joint training on the timbre extraction model and the song synthesis model. As illustrated in FIG. 2, FIG. 2 is a schematic diagram according to a second embodiment of the disclosure. On the basis of the embodiments of FIG. 1, the method described may further include the following.

At block 201, an initial joint model is obtained. The initial joint model includes an initial timbre extraction model and an initial song synthesis model subsequently connected to the initial timbre extraction model.

The input of the timbre extraction model is the audio and the output of the timbre extraction model is the timbre of the audio. The input of the song synthesis model is timbre, lyrics and tone and the output of the song synthesis model is the synthesized song multimedia.

At block 202, training data is obtained. The training data includes user audio samples, lyrics samples, tone samples, and corresponding song multimedia samples.

There are song multimedia of a large number of singers, lyrics and tunes of the song multimedia, and other audio of these singers corresponding song multimedia online. Therefore, the apparatus for song multimedia synthesis may obtain the audio samples, the lyrics samples, the tune samples and corresponding song multimedia samples of these singers as training data to train the initial joint model. The song multimedia samples may be song audio samples without background music, song audio samples with background music, or song video samples with background video, which may be set according to actual needs.

The apparatus for song multimedia synthesis may further obtain audio samples, lyrics samples, tune samples and corresponding song multimedia samples of a small number of common users, and add all the above samples to the training data.

At block 203, a trained joint model is obtained by training the initial joint model based on the training data.

At block 204, the timbre extraction model and the song synthesis model of the trained joint model are obtained.

In conclusion, the initial joint model is obtained. The initial joint model includes the initial timbre extraction model and the initial song synthesis model subsequently connected to the initial timbre extraction model. The training data is obtained. The training data includes user audio samples, lyrics samples, tone samples, and corresponding song multimedia samples. The trained joint model is obtained by training the initial joint model based on the training data. The timbre extraction model and the song synthesis model of the trained joint model are obtained. Therefore, the accuracy of the timbre extraction model and the accuracy of the song synthesis model are improved through the joint training of the timbre extraction model and the song synthesis model, and the accuracy of the synthesized song multimedia is improved.

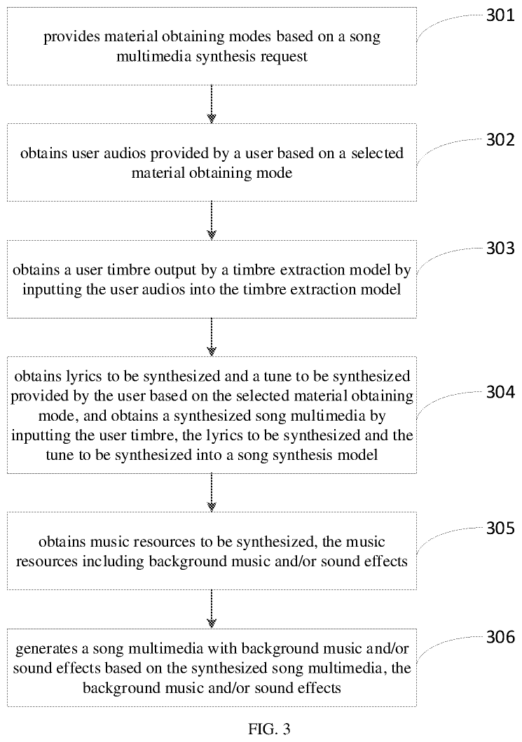

In order to improve the effect of the synthesized song multimedia, music resources may be added to the synthesized song multimedia. FIG. 3 is a schematic diagram of a third embodiment of the disclosure. The method further includes the following.

At block 301, material obtaining modes are provided based on a song multimedia synthesis request.

At block 302, user audios provided by a user are obtained based on a selected material obtaining mode.

At block 303, a user timbre output by a timbre extraction model is obtained by inputting the user audios into the timbre extraction model.

At block 304, lyrics to be synthesized and a tune to be synthesized provided by the user are obtained based on the selected material obtaining mode, and a synthesized song multimedia is obtained by inputting the user timbre, the lyrics to be synthesized and the tune to be synthesized into a song synthesis model.

At block 305, music resources to be synthesized are obtained. The music resources include background music and/or sound effects.

The background music may be background music that matches the tune to be synthesized, or background music that matches the rhythm of the tune to be synthesized.

At block 306, a song multimedia with background music and/or sound effects is generated based on the synthesized song multimedia, the background music and/or sound effects.

The sound effects may be, for example, sound of clapping, birdsong and rings. The process of generating the song multimedia with the background music and/or the sound effects by the apparatus for song multimedia synthesis may include: obtaining a rhythm of the synthesized song multimedia; obtaining a rhythm of the background music and/or a rhythm of the sound effect, and pairing the rhythm of the synthesized song multimedia with the rhythm of the background music and/or the rhythm of the sound effect; determining a position of each section of the background music and/or the sound effect in the synthesized song multimedia, and performing a synthesis process on the synthesized song multimedia, the background music and/or sound effect based on the position of each section of the background music and/or sound effect in the synthesized song multimedia to obtain the song multimedia with background music and/or sound effects. The section of the background music and/or sound effect refers to music note (i.e., a minimal component of the music) or a music phrase of the background music and/or sound effect.

The apparatus for song multimedia synthesis may add video resources to the song multimedia. Therefore, based on the embodiment of FIG. 3, the method may further include: obtaining video resources to be synthesized. Correspondingly, the block 306 may include: generating the song multimedia with the music resources and the video resources based on the synthesized song multimedia, the music resources and the video resources.

The synthesized song multimedia may be played, downloaded, delivered, shared and re-edited. The operation of the song multimedia may be selected according to actual needs.

In the disclosure, the music resources to be synthesized are obtained. The music resources include background music and/or sound effects. Based on the synthesized song multimedia, the background music and/or the sound effects, the song multimedia with the background music and/or the sound effects is generated. That is, music resources such as background music and/or sound effects can be added to the song multimedia to increase richness of the song multimedia.

In order to implement the above embodiments, the embodiments of the disclosure further provide an apparatus for synthesizing a song multimedia.

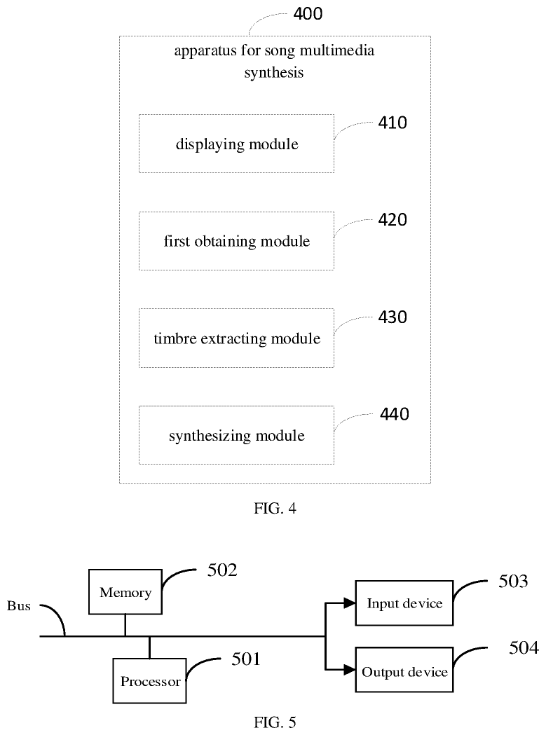

FIG. 4 is a schematic diagram of a fourth embodiment of the disclosure. As illustrated in FIG. 4, the apparatus for synthesizing a song multimedia 400 includes: a displaying module 410, a first obtaining module 420, a timbre extracting module 430 and a synthesizing module 440.

The displaying module 410 is configured to provide material obtaining modes based on a song multimedia synthesis request. The first obtaining module 420 is configured to obtain user audios provided by a user based on a selected material obtaining mode. The timbre extracting module 430 is configured to obtain a user timbre output by a timbre extraction model by inputting the user audios into the timbre extraction model. The synthesizing module 440 is configured to obtain lyrics to be synthesized and a tune to be synthesized provided by the user based on the selected material obtaining mode, and to obtain a synthesized song multimedia by inputting the user timbre, the lyrics to be synthesized and the tune to be synthesized into a song synthesis model.

In a possible implementation, the material obtaining modes include a timbre material obtaining mode, and the timbre material obtaining mode includes a user audio inputting interface and/or a user audio uploading interface. The first obtaining module 420 is configured to execute one of: collecting the user audios by an audio inputting device, based on an instruction of selecting the user audio inputting interface; or, obtaining the user audios uploaded by the user based on an instruction of selecting the user audio uploading interface.

In a possible implementation, the timbre material obtaining mode further includes one or more of a user timbre uploading interface, a designated timbre list, a historical timbre list, and a shared timbre list. The historical timbre list includes user timbres uploaded or extracted in a historical time period, and the shared timbre list includes user timbres shared in a historical time period. The apparatus also includes: a second obtaining module, configured to obtain an uploaded or selected user timbre based on an instruction of selecting the user timbre uploading interface, the designated timbre list, the historical timbre list, or the shared timbre list.

In a possible implementation, the material obtaining modes further include: a lyrics material obtaining mode. The lyric material obtaining mode includes one or more of a lyric uploading interface, a designated lyric list, a historical lyric list, and a shared lyric list. Obtaining the lyrics to be synthesized includes: obtaining uploaded or selected lyrics based on an instruction of selecting the lyrics upload interface, the designated lyrics list, the historical lyrics list, or the shared lyrics list.

In a possible implementation, the material obtaining modes further include: a tune material obtaining mode. The tune material obtaining mode includes one or more of a tune uploading interface, a designated tune list, a historical tune list and a shared tune list. Obtaining the tune to be synthesized includes: obtaining uploaded or selected tune based on an instruction of selecting the tune uploading interface, the designated tune list, the historical tune list, or the shared tune list.

In a possible implementation, the apparatus further includes a third obtaining module and a training module. The third obtaining module is configured to obtain an initial joint model, the joint model including an initial timbre extraction model and an initial song synthesis model sequentially connected to the initial timbre extraction model. Moreover, the third obtaining module is configured to obtain training data, the training data including user audio samples, lyrics samples, timbre samples, and corresponding song multimedia samples. Further, the third obtaining module is configured to obtain the timbre extraction model and the song synthesis model of the trained joint model. The training module is configured to obtain a trained joint model by training the initial joint model based on the training data.

In a possible implementation, the apparatus further includes: a fourth obtaining module and a first generating module. The fourth obtaining module is configured to obtain music resources to be synthesized, the music resources including background music and/or sound effects. The first generating module is configured to generate a song multimedia with background music and/or sound effects based on the synthesized song multimedia, the background music and/or sound effects.

In a possible implementation, the apparatus further includes: a fifth obtaining module and a second generating module. The fifth obtaining module is configured to obtain music resources to be synthesized and video resources. The second generating module is configured to generate a song multimedia with music resources and video resources based on the synthesized song multimedia, the music resources and the video resources.

With the apparatus for synthesizing a song multimedia according to embodiments of the disclosure, material obtaining modes are entered based on a song multimedia synthesis request. User audios provided by a user is obtained based on a selected material obtaining mode. A timbre output by a timbre extraction model is obtained by inputting the user audios into the timbre extraction model. Lyrics to be synthesized and a tune to be synthesized provided by the user are obtained based on the selected material obtaining mode, and a synthesized song multimedia is obtained by inputting the timbre, the lyrics to be synthesized and the tune to be synthesized into a song synthesis model. Therefore, materials are provided by users through different ways, to facilitate the users to provide materials based on their own conditions, so that operations required for users to generate song multimedia with their own timbre are reduced, and synthesis cost of the song multimedia is reduced, thereby improving synthesis efficiency of the song multimedia.

According to the embodiments of the disclosure, the disclosure also provides an electronic device and a readable storage medium.

FIG. 5 is a block diagram of an electronic device used to implement a method for synthesizing a song multimedia according to the embodiments of the disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the disclosure described and/or required herein.

As illustrated in FIG. 5, the electronic device includes: one or more processors 501, a memory 502, and interfaces for connecting various components, including a high-speed interface and a low-speed interface. The various components are interconnected using different buses and can be mounted on a common mainboard or otherwise installed as required. The processor may process instructions executed within the electronic device, including instructions stored in or on the memory to display graphical information of the GUI on an external input/output device such as a display device coupled to the interface. In other embodiments, a plurality of processors and/or buses can be used with a plurality of memories and processors, if desired. Similarly, a plurality of electronic devices can be connected, each providing some of the necessary operations (for example, as a server array, a group of blade servers, or a multiprocessor system). A processor 501 is taken as an example in FIG. 5.

The memory 502 is a non-transitory computer-readable storage medium according to the disclosure. The memory stores instructions executable by at least one processor, so that the at least one processor executes the method according to the disclosure. The non-transitory computer-readable storage medium of the disclosure stores computer instructions, which are used to cause a computer to execute the method according to the disclosure.

As a non-transitory computer-readable storage medium, the memory 502 is configured to store non-transitory software programs, non-transitory computer executable programs and modules, such as program instructions/modules (for example, the displaying module 410, the first obtaining module 420, the timbre extracting module 430, and the synthesizing module 440 shown in FIG. 4) corresponding to the method in the embodiments of the disclosure. The processor 501 executes various functional applications and data processing of the electronic device by running non-transitory software programs, instructions, and modules stored in the memory 502, that is, implementing the method in the foregoing method embodiments.

The memory 502 may include a storage program area and a storage data area, where the storage program area may store an operating system and application programs required for at least one function. The storage data area may store data created according to the use of the electronic device for implementing the method. In addition, the memory 502 may include a high-speed random access memory, and a non-transitory memory, such as at least one magnetic disk storage device, a flash memory device, or other non-transitory solid-state storage device. In some embodiments, the memory 502 may optionally include a memory remotely disposed with respect to the processor 501, and these remote memories may be connected to the electronic device for implementing the method through a network. Examples of the above network include, but are not limited to, the Internet, an intranet, a local area network, a mobile communication network, and combinations thereof.

The electronic device used to implement the method may further include: an input device 503 and an output device 504. The processor 501, the memory 502, the input device 503, and the output device 504 may be connected through a bus or in other manners. In FIG. 5, the connection through the bus is taken as an example.

The input device 503 may receive inputted numeric or character information, and generate key signal inputs related to user settings and function control of an electronic device for implementing the method, such as a touch screen, a keypad, a mouse, a trackpad, a touchpad, an indication rod, one or more mouse buttons, trackballs, joysticks and other input devices. The output device 504 may include a display device, an auxiliary lighting device (for example, an LED), a haptic feedback device (for example, a vibration motor), and the like. The display device may include, but is not limited to, a liquid crystal display (LCD), a light emitting diode (LED) display, and a plasma display. In some embodiments, the display device may be a touch screen.

Various embodiments of the systems and technologies described herein may be implemented in digital electronic circuit systems, integrated circuit systems, application specific integrated circuits (ASICs), computer hardware, firmware, software, and/or combinations thereof. These various embodiments may be implemented in one or more computer programs, which may be executed and/or interpreted on a programmable system including at least one programmable processor. The programmable processor may be dedicated or general purpose programmable processor that receives data and instructions from a storage system, at least one input device, and at least one output device, and transmits the data and instructions to the storage system, the at least one input device, and the at least one output device.

These computing programs (also known as programs, software, software applications, or code) include machine instructions of a programmable processor and may utilize high-level processes and/or object-oriented programming languages, and/or assembly/machine languages to implement these calculation procedures. As used herein, the terms “machine-readable medium” and “computer-readable medium” refer to any computer program product, device, and/or device used to provide machine instructions and/or data to a programmable processor (for example, magnetic disks, optical disks, memories, programmable logic devices (PLDs), including machine-readable media that receive machine instructions as machine-readable signals. The term “machine-readable signal” refers to any signal used to provide machine instructions and/or data to a programmable processor.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (egg, a communication network). Examples of communication networks include: local area network (LAN), wide area network (WAN), and the Internet.

The computer system may include a client and a server. The client and server are generally remote from each other and interacting through a communication network. The client-server relation is generated by computer programs running on the respective computers and having a client-server relation with each other.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of this application shall be included in the protection scope of this application.

What is claimed is:

1. A method for song multimedia synthesis, comprising:
providing material obtaining modes based on a song multimedia synthesis request;
obtaining user audios provided by a user based on a selected material obtaining mode;
obtaining a user timbre output by a timbre extraction model by inputting the user audios into the timbre extraction model; and
obtaining lyrics to be synthesized and a tune to be synthesized provided by the user based on the selected material obtaining mode, and obtaining a synthesized song multimedia by inputting the user timbre, the lyrics to be synthesized and the tune to be synthesized into a song synthesis model.

2. The method of claim 1, wherein the material obtaining modes comprise a timbre material obtaining mode, and the timbre material obtaining mode comprises a user audio inputting interface and/or a user audio uploading interface; and
wherein obtaining the user audios comprises one of:
collecting the user audios by an audio inputting device, based on an instruction of selecting the user audio inputting interface; or,
obtaining the user audios uploaded by the user based on an instruction of selecting the user audio uploading interface.

3. The method of claim 2, wherein the timbre material obtaining mode further comprises one or more of a user timbre uploading interface, a designated timbre list, a historical timbre list, and a shared timbre list; and the historical timbre list comprises user timbres uploaded or extracted in a historical time period, and the shared timbre list comprises user timbres shared in a historical time period; and
the method further comprises:
obtaining an uploaded or selected user timbre based on an instruction of selecting the user timbre uploading interface, the designated timbre list, the historical timbre list, or the shared timbre list.

4. The method of claim 1, wherein the material obtaining modes further comprise: a lyrics material obtaining mode;
the lyric material obtaining mode comprises one or more of a lyric uploading interface, a designated lyric list, a historical lyric list, and a shared lyric list; and
obtaining the lyrics to be synthesized comprises: obtaining uploaded or selected lyrics based on an instruction of selecting the lyrics upload interface, the designated lyrics list, the historical lyrics list, or the shared lyrics list.

5. The method of claim 1, wherein the material obtaining modes further comprise: a tune material obtaining mode;
the tune material obtaining mode comprises one or more of a tune uploading interface, a designated tune list, a historical tune list and a shared tune list; and
obtaining the tune to be synthesized comprises: obtaining uploaded or selected tune based on an instruction of selecting the tune uploading interface, the designated tune list, the historical tune list, or the shared tune list.

6. The method of claim 1, further comprising:
obtaining an initial joint model, the initial joint model comprising an initial timbre extraction model and an initial song synthesis model subsequently connected to the initial timbre extraction model;
obtaining training data, the training data comprising user audio samples, lyrics samples, tone samples, and corresponding song multimedia samples;
obtaining a trained joint model by training the initial joint model based on the training data; and
obtaining the timbre extraction model and the song synthesis model of the trained joint model.

7. The method of claim 1, further comprising:
obtaining music resources to be synthesized, the music resources comprising background music and/or sound effects; and
generating a song multimedia with background music and/or sound effects based on the synthesized song multimedia, the background music and/or sound effects.

8. The method of claim 1, further comprising:
obtaining music resources to be synthesized and video resources; and
generating a song multimedia with music resources and video resources based on the synthesized song multimedia, the music resources and the video resources.

9. An electronic device, comprising:
at least one processor; and
a memory communicatively connected with the at least one processor;
wherein, the memory stores instructions executable by the at least one processor, and when the instructions are executed by the at least one processor, the at least one processor is configured to:
provide material obtaining modes based on a song multimedia synthesis request;
obtain user audios provided by a user based on a selected material obtaining mode;
obtain a user timbre output by a timbre extraction model by inputting the user audios into the timbre extraction model; and
obtain lyrics to be synthesized and a tune to be synthesized provided by the user based on the selected material obtaining mode, and obtain a synthesized song multimedia by inputting the user timbre, the lyrics to be synthesized and the tune to be synthesized into a song synthesis model.

10. The electronic device of claim 9, wherein the material obtaining modes comprise a timbre material obtaining mode, and the timbre material obtaining mode comprises a user audio inputting interface and/or a user audio uploading interface; and
the processor is further configured to obtain the user audios by one of:
collecting the user audios by an audio inputting device, based on an instruction of selecting the user audio inputting interface; or,
obtaining the user audios uploaded by the user based on an instruction of selecting the user audio uploading interface.

11. The electronic device of claim 10, wherein the timbre material obtaining mode further comprises one or more of a user timbre uploading interface, a designated timbre list, a historical timbre list, and a shared timbre list; and the historical timbre list comprises user timbres uploaded or extracted in a historical time period, and the shared timbre list comprises user timbres shared in a historical time period; and
the processor is further configured to: obtain an uploaded or selected user timbre based on an instruction of selecting the user timbre uploading interface, the designated timbre list, the historical timbre list, or the shared timbre list.

12. The electronic device of claim 9, wherein the material obtaining modes further comprise: a lyrics material obtaining mode;
the lyric material obtaining mode comprises one or more of a lyric uploading interface, a designated lyric list, a historical lyric list, and a shared lyric list; and
the processor is configured to obtain the lyrics to be synthesized by obtaining uploaded or selected lyrics based on an instruction of selecting the lyrics upload interface, the designated lyrics list, the historical lyrics list, or the shared lyrics list.

13. The electronic device of claim 9, wherein the material obtaining modes further comprise: a tune material obtaining mode;
the tune material obtaining mode comprises one or more of a tune uploading interface, a designated tune list, a historical tune list and a shared tune list; and
the processor is configured to obtain the tune to be synthesized by obtaining uploaded or selected tune based on an instruction of selecting the tune uploading interface, the designated tune list, the historical tune list, or the shared tune list.

14. The electronic device of claim 9, wherein the processor is further configured to:
obtain an initial joint model, the initial joint model comprising an initial timbre extraction model and an initial song synthesis model subsequently connected to the initial timbre extraction model;
obtain training data, the training data comprising user audio samples, lyrics samples, tone samples, and corresponding song multimedia samples;
obtain a trained joint model by training the initial joint model based on the training data; and
obtain the timbre extraction model and the song synthesis model of the trained joint model.

15. The electronic device of claim 9, wherein the processor is further configured to:
obtain music resources to be synthesized, the music resources comprising background music and/or sound effects; and
generate a song multimedia with background music and/or sound effects based on the synthesized song multimedia, the background music and/or sound effects.

16. The electronic device of claim 9, wherein the processor is further configured to:
obtain music resources to be synthesized and video resources; and
generate a song multimedia with music resources and video resources based on the synthesized song multimedia, the music resources and the video resources.

17. A non-transitory computer-readable storage medium having computer instructions stored thereon, wherein the computer instructions are configured to cause a computer to execute a method for song multimedia synthesis, the method comprising:
providing material obtaining modes based on a song multimedia synthesis request;
obtaining user audios provided by a user based on a selected material obtaining mode;
obtaining a user timbre output by a timbre extraction model by inputting the user audios into the timbre extraction model; and
obtaining lyrics to be synthesized and a tune to be synthesized provided by the user based on the selected material obtaining mode, and obtaining a synthesized song multimedia by inputting the user timbre, the lyrics to be synthesized and the tune to be synthesized into a song synthesis model.

18. The non-transitory computer-readable storage medium of claim 17, wherein the material obtaining modes comprise a timbre material obtaining mode, and the timbre material obtaining mode comprises a user audio inputting interface and/or a user audio uploading interface; and
wherein obtaining the user audios comprises one of:
collecting the user audios by an audio inputting device, based on an instruction of selecting the user audio inputting interface; or,
obtaining the user audios uploaded by the user based on an instruction of selecting the user audio uploading interface.

19. The non-transitory computer-readable storage medium of claim 18, wherein the timbre material obtaining mode further comprises one or more of a user timbre uploading interface, a designated timbre list, a historical timbre list, and a shared timbre list; and the historical timbre list comprises user timbres uploaded or extracted in a historical time period, and the shared timbre list comprises user timbres shared in a historical time period; and
the method further comprises:
obtaining an uploaded or selected user timbre based on an instruction of selecting the user timbre uploading interface, the designated timbre list, the historical timbre list, or the shared timbre list.

20. The non-transitory computer-readable storage medium of claim 17, wherein the method further comprises:
obtaining an initial joint model, the initial joint model comprising an initial timbre extraction model and an initial song synthesis model subsequently connected to the initial timbre extraction model;
obtaining training data, the training data comprising user audio samples, lyrics samples, tone samples, and corresponding song multimedia samples;
obtaining a trained joint model by training the initial joint model based on the training data; and
obtaining the timbre extraction model and the song synthesis model of the trained joint model.
